(19) United States
(12) Patent Application Publication
(10) Pub. No.: US 2010/0121235 A1
(43) Pub. Date: May 13, 2010

(54) MASSAGE LEVER

(76) Inventor: Nicholas Sasano, Newport Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/268,631

(22) Filed: Nov. 11, 2008

(51) Int. Cl. A61H 7/00; A61H 1/02

(52) U.S. Cl. 601/136; 601/134; 601/24

(57) ABSTRACT

A personal portable massage lever having a pair of elongated upstanding posts adapted to be secured to the back and seat of a chair. A pivoted rod is mounted between the upper ends of the posts and has a shoulder-massaging device adapted to abut against one's shoulders to massage the same when the user sits on the chair with his or her back against the posts. The posts may be secured directly to he back of the chair or be resiliently secured to a base resting on the seat of the chair.

### BACKGROUND

1. Field

This disclosure relates to a portable apparatus for massaging one's shoulders.

2. General Background

Various exercising and massaging devices are known in the art. For example, there are hand held acupressure devices, and massage devices, appliances, instruments, and exercisers, including sliding and rolling devices and multidirectional devices. The prior art also teaches devices for treating muscular ailments. These devices are specifically designed for the back but may, as well, be applied to other portions of the body. However, the prior art does not teach a portable shoulder massage and exercising device for applying massage contact to one's shoulder wherein one can sit on a chair while massaging one's shoulders.

### SUMMARY

It is an object of this disclosure to provide a portable shoulder-massaging device which can be quickly and easily mounted on, or be adapted to be used with, a conventional chair having a seat and back.

It is a further object of this disclosure to carry out the foregoing object by providing a device that has a base that mounts on top of the seat of the chair and the user can apply a massager to his or her shoulders.

It is still further an object of this disclosure to provide such a massaging device which can either be physically secured to the seat of a chair, or be secured to the back of the chair, while massaging is carried out.

These and other objects are accomplished by providing a massage lever having a pair of upstanding posts with a massaging rod pivotally mounted therebetween. The rod is located at a height such that the rod is extended over the top of the user's shoulders. The user then pivots the rod against his or her shoulder to massage the same.

The height of the rod may be adjusted and the rod may have a ridged surface thereon for increasing the massaging action.

### DRAWINGS

The above-mentioned features and objects of the present disclosure will become more apparent with reference to the following description taken in conjunction with the accompanying drawings wherein like reference numerals denote like elements and in which:

FIG. 1 is a front elevational view of the massage lever of the disclosure;

FIG. 2 is a side elevational view of the massage lever of FIG. 1;

FIG. 3 is a view taken along lines 3-3 of FIG. 2;

FIGS. 4 and 5 are diagrammatic views illustrating the operation of the massage lever of FIGS. 1 to 3;

FIG. 6 is an elevational view of the massage lever of FIGS. 1 to 5 having a resilient ball mounted thereon; and

FIG. 7 is a modification of the massage lever of FIGS. 1 to 6.

### DETAILED DESCRIPTION

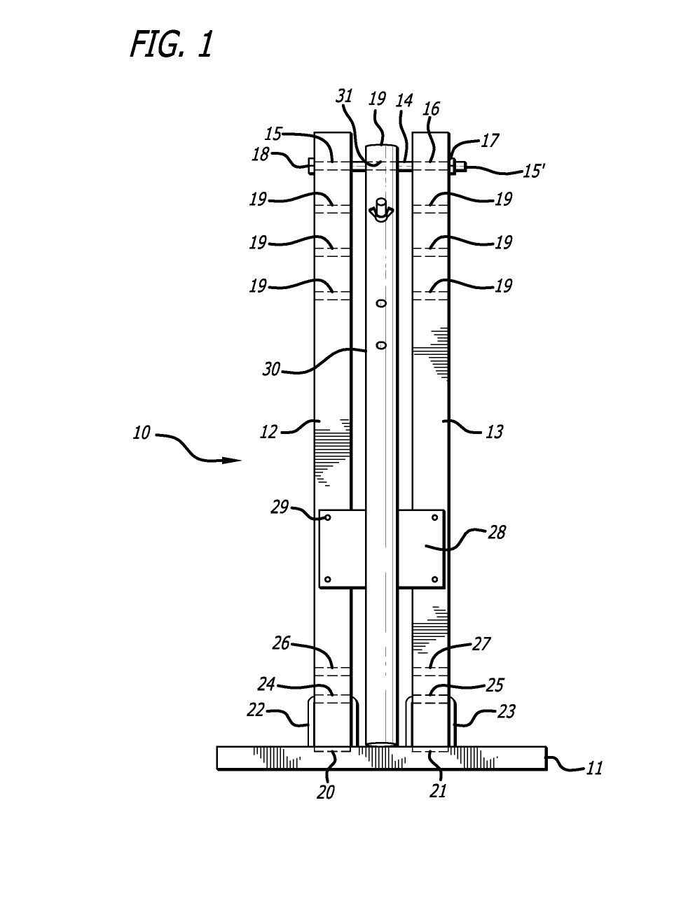

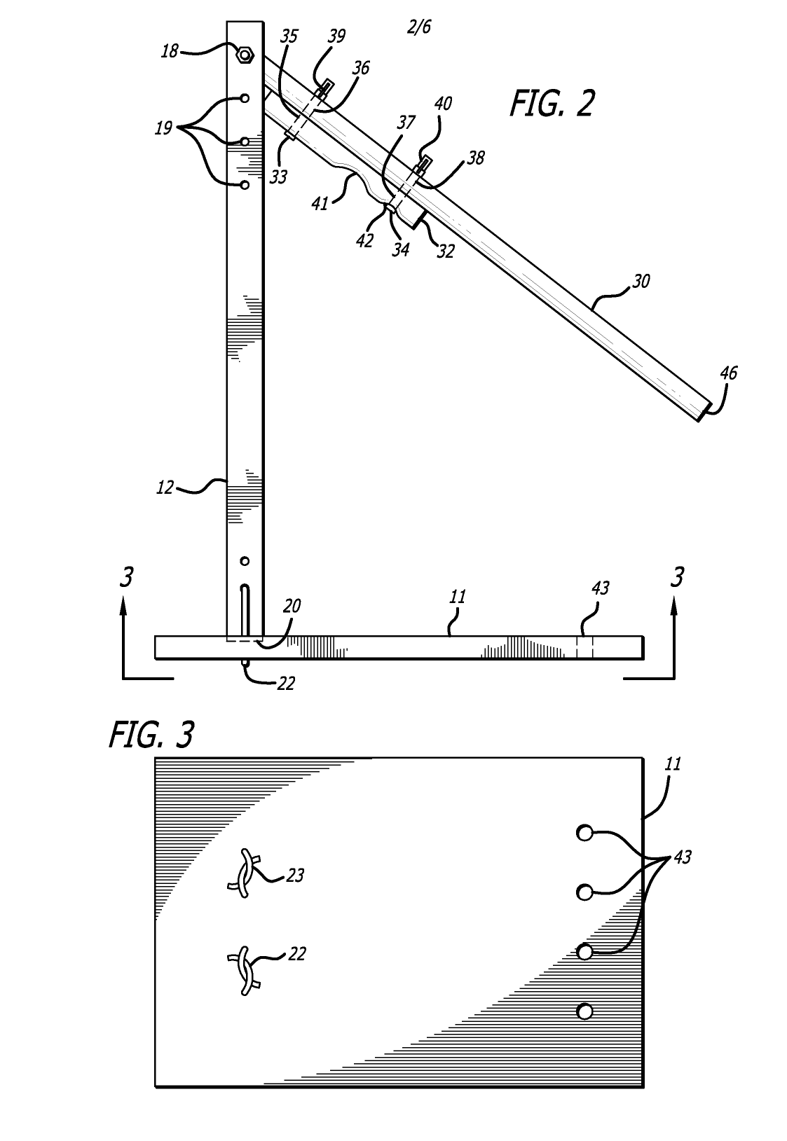

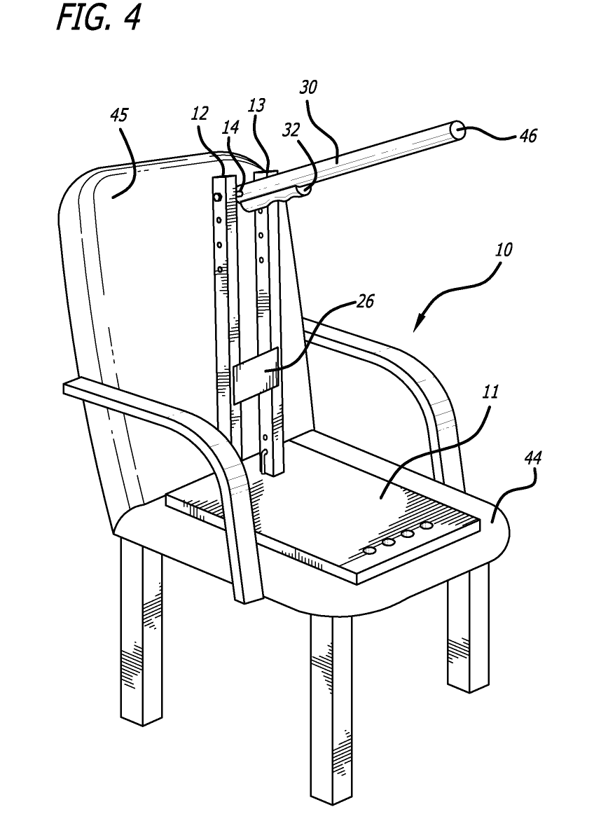

Referring now to FIG. 1 of the drawing, a massage lever 10 is shown having a planar base 11 (see FIG. 3). Massage lever 10 (FIG. 1) has a pair of spaced upstanding posts 12, 13, which may be square-shaped in cross-section, having a throughbolt 14 at top extending through aligned holes 15, 16 in posts 12, 13. Throughbolt 14 is threaded at end 15′ for receiving a locking nut 17 thereon. The head 18 of throughbolt 14 abuts against the outside of the post 12. As seen in FIG. 2, a plurality of aligned spaced holes 19 may be provided on posts 12, 13 for varying the height of throughbolt 14 with respect to base 11.

As seen in FIGS. 1 and 2, a pair of cavities 20, 21 are provided in the base 11 for receiving the lower ends of posts 12, 13 therein. These lower ends may be pivotally held in cavities 20, 21 by resilient members 22, 23, respectfully, which extend through hole 24, 25, respectively, in the lower ends of posts 12, 13 and are secured, by having their ends tied together, on the underside of base 11 as seen in FIGS. 2 and 3. In this manner, posts 12, 13 can pivot within cavities 20, 21 and are resiliently retained to base 11.

Like aligned spaced holes 26, 27 are provided in posts 12, 13, above hole 24, 25, for varying the degree of resiliency or accommodating resilient members of differing lengths and resiliency.

As seen in FIG. 1, a plate 28 may be secured to posts 12, 13, as by screws 29, for providing support to massage lever 10.

As particularly contemplated in the present disclosure, the portion of throughbolt 14 between posts 12, 13 is smooth on the exterior and passes through a hole 31 in an elongated massage lever or rod 30. Rod 30 may be circular in cross-section and hole 31 in rod 30 may be slightly larger in diameter than the diameter of throughbolt 14 to provide for a certain degree of pivotal movement of rod 30 with respect to throughbolt 14.

As seen in FIG. 2, rod 30 may have an elongated smooth ridged shoulder-massaging device 32 mounted to the underside of rod and secured to rod 30 by one or more threaded bolts 33, 34 extending through aligned holes 35, 36 and 37, 38, in device 32 and rod 30, respectively. These bolts are retained to rod 30 by wing nuts 39, 40, respectively.

Device 32 has a plurality of smooth spaced ridges 41, 42 on the underside for reasons to be discussed.

As seen in FIG. 3, a plurality of spaced holes 43 extended through base 11 for securing the same to the seat of a chair or the like for added support, if desired, by passing resilient members (not shown) through holes 43 and under the chair seat.

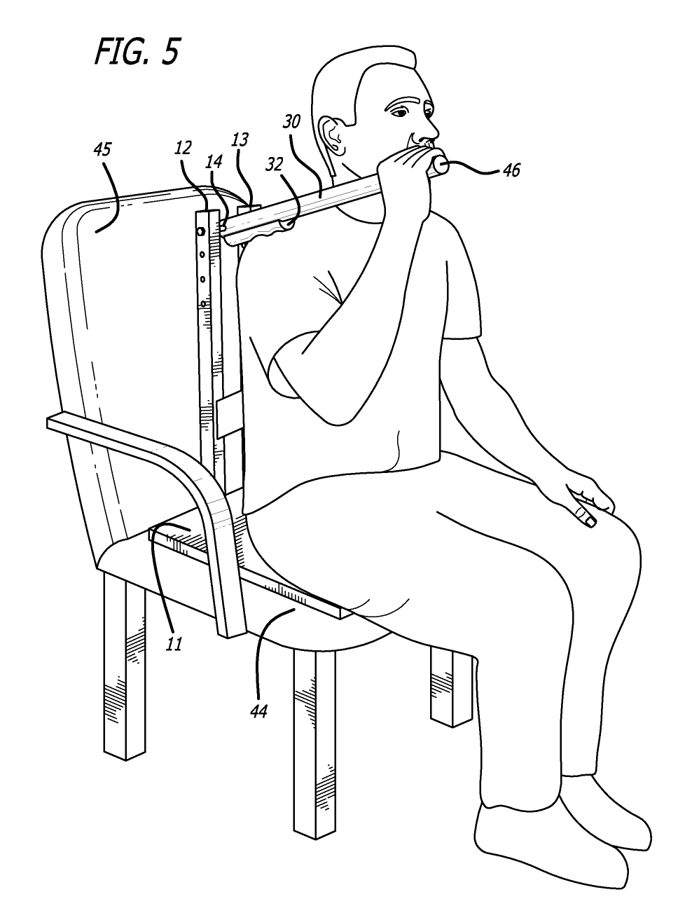

The operation of massage lever 10 is shown in FIG. 4. The base 11 is placed on the seat 44 of a chair with posts 12, 13 abutting against the back 45 of the chair. The user sits on top of base 11 (FIG. 5) with his or her back against posts 12, 13 and grasps the end 46 of rod 30, with massaging device 32 on top of one's shoulders. The rod 30 then is pivoted up and down thereby massaging one's shoulders. The rod 30 can be shifted along throughbolt 14 to massage the other shoulder.

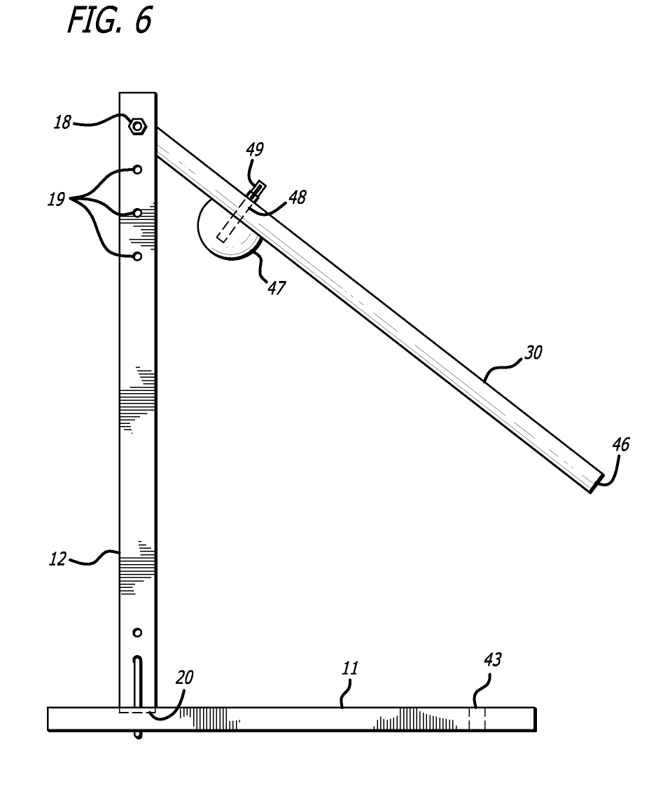

Instead of a separate massaging device 32, the rod 30 itself may be ridged. Also, other massaging devices may be used such as a resilient ball 47 (FIG. 6) having a throughbore 48 with a bolt 49 extending through aligned holes 19, 48 in rod 30 and ball 47, respectively. The rod 30 is used exactly as seen in FIGS. 4 and 5, ball 47 doing the shoulder massaging instead of device 32.

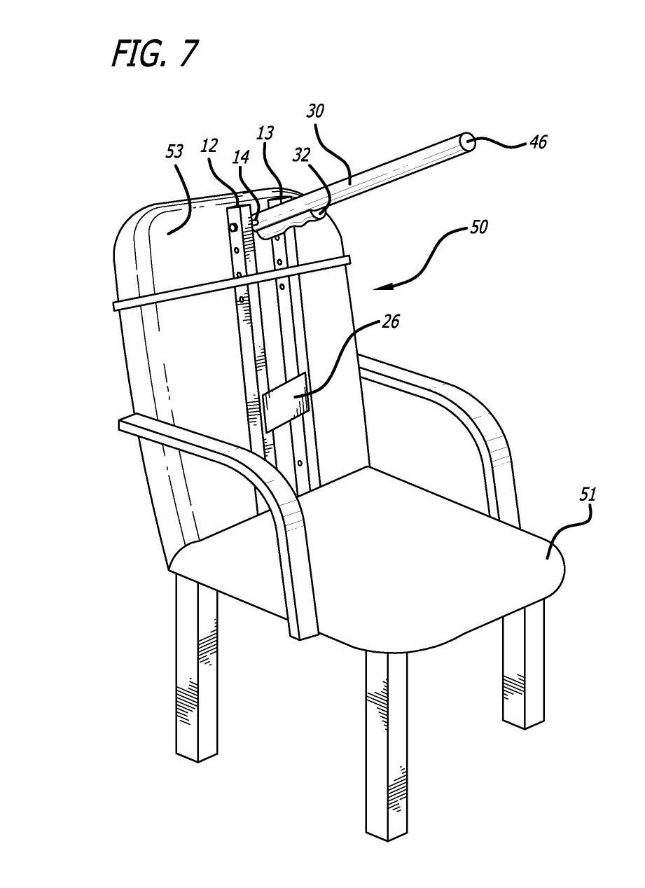

Although a base 11 is shown in FIGS. 1 to 5, base 11 may be eliminated and the posts 12, 13 may be secured directly to the back of a chair as shown in FIG. 7.

Thus, massage lever 50, otherwise identical to massage lever 10, does not have a base but has the posts 12, 13 which are directly secured to the back 53 of a chair with the lower ends of the posts 12, 13 abutting against the top of seat 51.

Massage lever 50 is used exactly the same as massage lever 10 with the user sitting on seat 51 with his or her back against posts 12, 13. Rod 30 is used exactly as shown in FIGS. 4 and 5.

The foregoing description is intended to be illustrative and not limiting. Obvious variations will occur to those skilled in the art. The disclosure is intended to encompass all such variations and be limited only by the scope and spirit of the appended claims.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A personal portable massage lever compromising:
a pair of spaced rigid elongated posts;
an elongated rod pivotally mounted between the posts adjacent the upper ends thereof;
securement means adapted to secure the posts to the back and seat of a chair; and
a shoulder-massaging device mounted on the side of said rod adapted to face said seat of said chair when said posts are secured to the back and seat of a chair.

2. The massage lever of claim 1 wherein a planar base is provided, said posts having upper and lower ends, said lower ends being remote from said rod extending into spaced cavities in said base.

3. The massage lever of claim 2 wherein said lower ends are resiliently secured to said base.

4. The massage lever of claim 1 including a support plate interconnecting said posts below said rod.

5. The massage lever of claim 1 wherein said posts have upper and lower ends and said rod is pivotally mounted between said posts to a throughbolt extending through aligned holes in the upper ends of said posts.

6. The massage lever of claim 5 wherein said throughbolt is smooth on its outer surface between said posts.

7. The massage lever of claim 6 wherein the throughbolt extends though a hole in said rod, said hole being slightly greater in diameter than the diameter of said throughbolt.

8. The massage lever of claim 1 wherein said shoulder massaging device has a plurality of smooth ridges on the side thereof facing said seat.

9. The massage lever of claim 1 wherein said shoulder massaging device is a resilient ball mounted on said rod.

10. The massage lever of claim 1 whereon said posts have upper and lower ends and a plurality of spaced aligned holes extend along the upper ends of said posts.

11. A personal portable massage lever comprising:
at least one rigid elongated post, said post having an extension portion at the upper end thereof; and
a shoulder massaging device mounted on said extension portion facing the lower end of said post.

12. The lever of claim 11, wherein said shoulder massaging device is a resilient ball mounted on said extension portion.

13. The lever of claim 11 having a planar base pivotally connected to the lower end of said post.
